(19) United States
(12) Patent Application Publication
(10) Pub. No.: US 2002/0165062 A1
(43) Pub. Date: Nov. 7, 2002

(54) Elevated rotational transmission mechanism

(76) Inventor: Jui Tsui Huang, Sanchung City (TW)

Correspondence Address: Dougherty & Troxell, ONE SKYLINE PLACE, SUITE 1404, 5205 LEESBURG PIKE, FALLS CHURCH, VA, 22401, US

(21) Appl. No.: 09/846,292

(22) Filed: May 2, 2001

(51) Int. Cl. F16H 57/08

(52) U.S. Cl. 475/331

(57) ABSTRACT

An elevated rotational transmission mechanism comprises a transmitting device, a rotary disc, an upright post, a movable rotor, and a plurality of movable rods. The shaft at the bottom of the transmitting device rotates under a restriction of the upright post to make the rotary disc and the transmitting device rotate in one direction. The transmitting shaft of the transmitting device and the driving gear rotate along with the rotary disc to force the driven gear, which meshes with the driving gear, rotates in another direction. The respective support arm on each movable rod displaces along the wave-shaped rail, which rotates in the reverse direction, and moves up and down in the guide groove of the respective elongated sleeve disposed on the rotary disc to result in the decorative article at the lower part of the respective movable rod rotates and moves up and down synchronously.

### BACKGROUND OF THE INVENTION

1. Field of The Invention

The present invention relates to an elevated rotational transmission mechanism, and, in particular, the present invention relates to transmission mechanism, in which a transmitting device can rotate along with a rotary disc and a plurality of movable rods disposed at the periphery of the rotary disk can move up and down along a movable rotor.

2. Description of Related Art

It is known that the turn-about in an amusement field had really given us a lot of surprises and pleasures while we were in the childhood. Hence, there must have an attractive reason that the amusement facilities providing a rotation and an up and down movement can be so long lasting till now.

Accordingly, the toy maker has tried to minimize the turn-about and has presented a variety of turn-about toys capable of rotating and going up and down as the turn-about in the amusement field does and these toys are loved very much by many people regardless adults and children. Taking U.S. Pat. No. 5,276,271, which is granted on Jan. 4, 1994 and entitled “Music Box Motion Generation Mechanism”, as an example, the music box at the bottom of a mount case thereof provides a driving unit with a shaft extending downward from the center of the driving spring thereof to engage with a security nut through an upper housing cavity. Further, the security nut fastens to a main shaft by way of screw threads so as to hold a rotation disc together with an open end of the mount case such that the main shaft with a decoration umbrella at the upper part thereof may rotate with the shaft synchronously. The crux of the prior art resides in that a wave-shaped cam ring is arranged in the upper housing cavity and a movable rod is disposed above each circumferential hole at the periphery of the rotation disc with a decoration article at the top thereof. The respective movable rod at the lower end thereof passes through the respective hole to engage with a ring and a follower means with inner threads so that each follower means contacts with the wave-shaped cam. When the rotation disc rotates, the movable rods and the decoration articles rotate along with the rotation disc. Moreover, the movable rods move up and down due to the follower means at the lower end of respective movable rod moving along the wave-shaped cam ring. Hence, the prior art can offer a rotation and an up and down movement.

However, the prior art provides a sophisticate device and it makes the production cost increase greatly while the complicate assembling job is performed. Moreover, the total weight including the movable rods and the decoration articles, which presses on the wave-shaped cam ring during moving upward and downward, may result in not only a slight retard of the up and movement but also a rough movement. In addition, the arrangement for the movable rods being mounted on the rotation disc is not quite the same arrangement as the actual amusement facilities so that it is hard for the player to have a feeling like playing the actual turn-about while a toy with a device of the prior art is used.

### SUMMARY OF THE INVENTION

An object of the present invention is to provide an elevated rotational transmission mechanism, which offer an arrangement with simpler component parts for an up and down movement with easier operation.

### BRIEF DESCRIPTION OF THE DRAWINGS

The present invention can be more fully understood by referring to the following description and accompanying drawings, in which:

FIG. 1 is an exploded perspective view of an elevated rotational transmission mechanism according to the present invention;

FIG. 2 is a top view of the transmission mechanism shown in FIG. 1 after assembling;

FIG. 3 is an assembled perspective view of the transmission mechanism shown in FIG. 1;

FIG. 4 is a perspective view of a movable rotor in the transmission mechanism according to the present invention; and

FIG. 5 is a perspective view of a movable rotor in the transmission mechanism according to the present invention in another embodiment thereof.

### DETAILED DESCRIPTION OF THE PREFERRED EMBODIMENTS

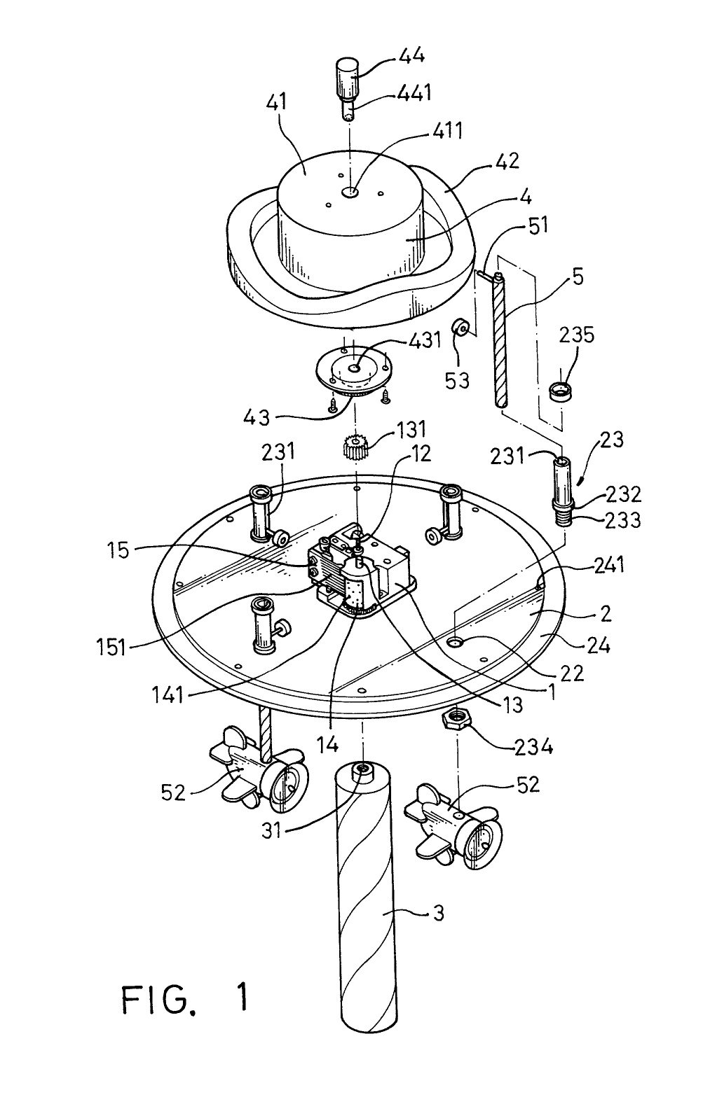

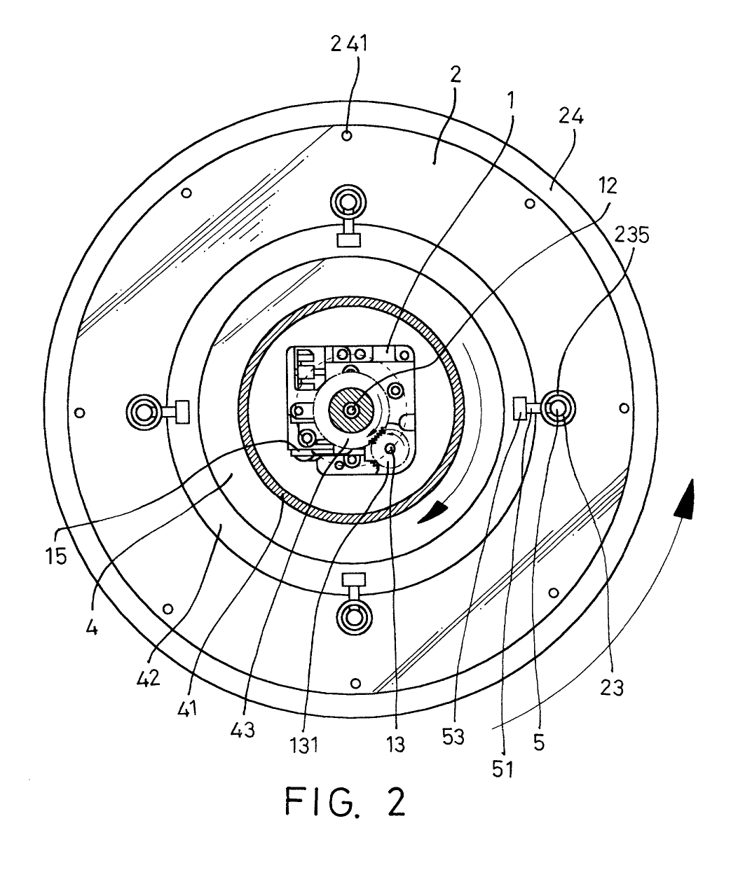

Referring to FIGS. 1 to 3, an elevated rotational transmission mechanism according to the present invention basically comprises a transmitting device 1, a rotary disc 2, an upright post 3, a movable rotor 4, and a plurality of movable rods 5.

Wherein, the transmission device 1 is a mover source and a shaft 11 extends downward from the bottom thereof (not shown in the figure due to the projected angle) to fixedly engage with the upright post 3 through the rotary disc 2, for instance, by way of screw threads. The transmitting device 1 at the upper central position provides a vertical locating stem 12 and a transmitting shaft 13 extends beside the locating stem to fit with a primary gear 131.

In fact, the transmitting device 1, as shown in the figures, may be a conventional music bell so that the spring shaft thereof is identical with the preceding shaft 11, and the transmitting shaft 13 laterally extends outward from a stirred wheel 14. The stirred wheel 14 at the outer surface thereof has a plurality of protruded granules 141 to contact with a plurality of spring sheets 151 in a spring sheet section 15 during the stirred wheel 14 in a state of rotation so that it is possible to generate sweet sounding music.

The rotary disc 2 is circular and at the center thereof is fixed by the transmitting device 1. The rotary disc 2 provides an axial hole 21 (not shown) to be passed through by the shaft 11. Besides, the rotary disc 2 at the circumferential rim thereof provides a plurality of locating holes 22 to fixedly engage with an elongated sleeve 23 respectively. The elongated sleeve 23 has an inner guide groove 231, and at the bottom thereof projects a stop ring 232 and extends downward a threaded section 233 to engage with a nut 234 through the respective locating hole 22. Thus, the stop ring 232 is disposed to stride above the locating hole 22. Moreover, the rotary disc 2 at the periphery thereof provides a circumferential rim 24 with a plurality of circumferential holes 241 such that the conventional umbrella-shaped cover can fix to the rim 24 by way of adhesive or engage with the rim 24 by way of screws passing through the circumferential holes.

The upright post 3 is vertically elongated and has an upper central hole 31 fitting with the shaft 11. The lower part of the upright post 3 connects with a conventional base.

The movable rotor 4 is cap-like shape with an upper cylindrical head 41 and a central fitting hole 411 is provided on the cylindrical head 41. The movable rotor 4 at the periphery thereof provides a circumferential wave-shaped rail 42 with an up and down contour. Besides, a driven gear 43 is fixedly attached to the inner wall of the cylindrical head 41 such that a central through hole 431 of the driven gear 43 can align with the fitting hole 411. A connecting rod 44 at a lower fitting end 441 thereof passes through the aligned holes 431, 411 to connect with the locating stem 12 such that the driven gear 43 can mesh with the driving gear 131 and the entire movable rotor 4 can be movably mounted above the rotary disc 2.

Each movable rod 5 is inserted into each elongated sleeve 23 and provides an upper support arm 51 to extend outward laterally through the guide groove 231 and keep contact with the contour surface on the wave-shaped rail 42. The respective movable rod 5 at the lower end thereof may join a conventional decorative article 52. Furthermore, the support arm 51 at the free end thereof may fit with a bearing 53 for contacting with the wave-shaped rail 42 to reduce the generated friction force as soon as the support arm 51 moves along the wave-shaped rail 42. In addition, the elongated sleeve 23 at the upper end thereof may provide a detachable limit ring 235 to prevent the support arm 52 from being apart from the elongated sleeve 23 while the support arm 52 moves upward along the guide groove 231.

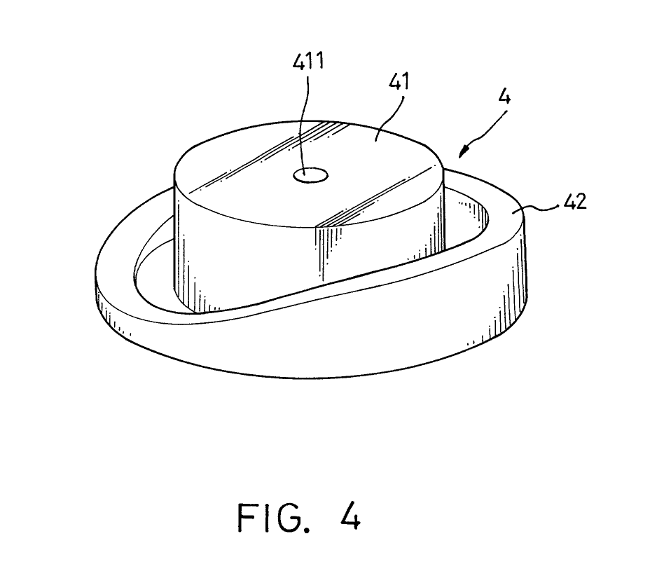

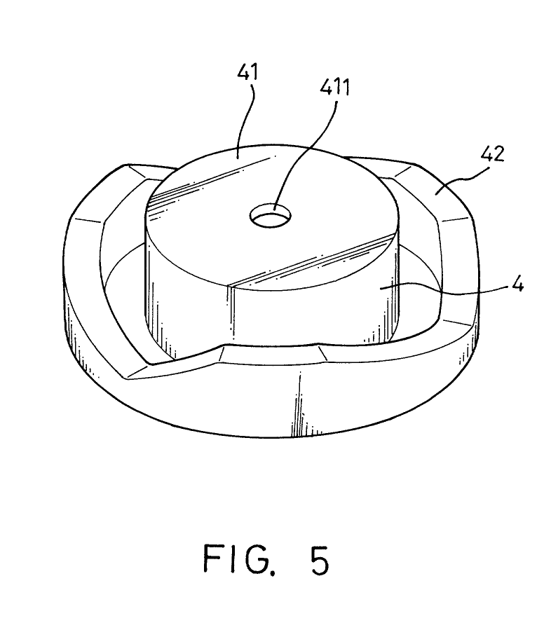

Referring to FIGS. 1, 4, and 5, the contour on the wave-shaped rail 42 can be provided with a plurality of up and down arc surfaces as shown in FIG. 1, a continuously slant surface as shown in FIG. 4, or a plurality of up and down straight surfaces as shown in FIG. 5 such that the decorative article 52 under the movable rod 5 can provide different modes of up and down movements flexibly as desired.

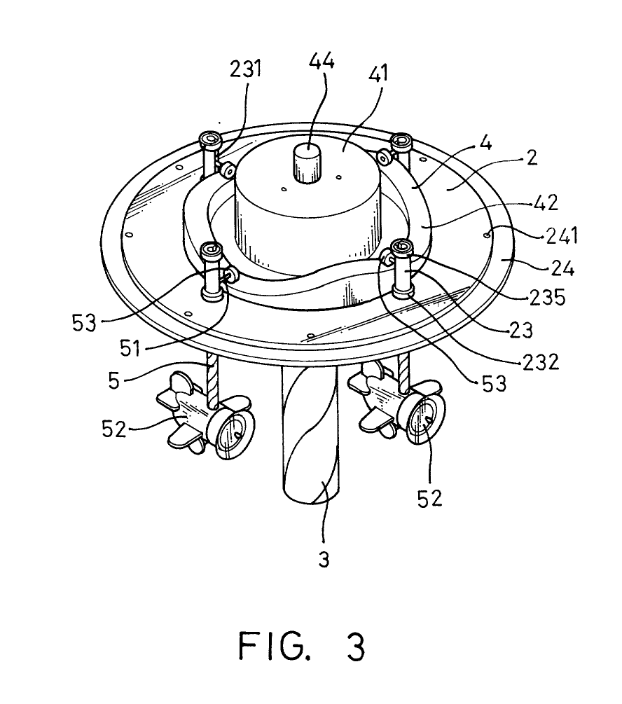

Referring to FIGS. 1 to 3, each component in the transmission mechanism of the present invention has been disclosed in the preceding description and a complete appearance of the transmission mechanism is shown in FIG. 3 as soon as the theses components are assembled. When the transmission mechanism goes into operation, the shaft 11 is started to turn first under a restriction of the upright post 3. Once a music bell is used as the transmitting device 1, the rotary disc 2 being turned in a clockwise direction may tight up the spring in the music bell because the transmitting device is disposed at the center of the rotary disc 2. Next, the rotary disc 2 and the transmitting device 1 rotate in the counterclockwise direction due to the resilient force of the tight spring. In the mean time, the transmitting shaft 13 and the driving gear 43 may rotate synchronously. Hence, the driven gear 43, which meshes with the driving gear 43, is forced to rotate clockwise. Because the driven gear 43 is fixed in the movable rotor 4, the movable rotor 4 rotates in a direction opposite to the rotary disc 2. It is noted that the arrangement is helpful for the support arms 51 on the movable rod 5 to free from the influence of the friction force while the support arms 51 displace along the wave rail 42. The provision of the bearing 53 at the free end of each support arm 51 can enhance the displacement in a state of smoothness such that the support arms 51 can move upward and downward in the respective guide groove following the elevation changes of the contour on the wave-shaped rail 42. In this way, the decorative article at the lower end of the movable rod 5 ascends and descends accordingly to perform a rotation as well as a movement of going up and down.

It is appreciated from the preceding descriptive explanation of preferred embodiments that the elevated rotational transmission mechanism according to the present invention provides simplified component parts to make the assembly job fast so as to lower down the production cost greatly. Besides, each movable rod arranged in the transmission mechanism of the present invention rotates along with the rotary disc and a laterally extended support arm thereof moving along a wave-shaped rail in reverse such that it can be assured that the movable rods can rise and fall smoothly. In addition, the movable rods being disposed in a state of suspending is identical with the arrangement in the conventional amusement facilities so that it is easy for the user to remind the past with regard to his childhood.

While the invention has been described with reference to preferred embodiments thereof, it is to be understood that modifications or variations may be easily made without departing from the spirit of this invention, which is defined by the appended claims.

What is claimed is:

1. An elevated rotational transmission mechanism, comprising
a transmitting device, being a mover source, providing a first shaft at a bottom thereof, a second shaft extending at a lateral side thereof, and the transmitting shaft fitting with a driving gear;
a rotary disc, providing a central position thereof being disposed the transmitting device, having an axial hole to be passed by the first shaft on the transmitting device, providing a plurality of circumferential hole at a periphery thereof to locate an elongated sleeve respectively, and the respective elongated sleeve having an inner guide groove;
an upright post, an upper part thereof joining the first shaft on the transmitting device, a lower part thereof providing a stationary base to support all parts above the rotary disk;
a movable rotor, providing a cylindrical head and a wave-shaped rail with an up and down contour surrounding the cylindrical head, the cylindrical head having an inner wall, a driven gear being fixedly disposed at a top of the inner wall, a connecting rod passing through the cylindrical head and the driven gear to movably engage with a locating stem for the movable rotor being disposed above the rotary disk movably;
a plurality of movable rods, being inserted in the elongated sleeves respectively, the movable rods each extending laterally an upper support arm respectively, an end of the respective support arm being received in the guide groove and another end thereof keeping contact with the contour on the wave-shaped rail, and the respective movable rod at a lower part thereof connecting a decorative article;
whereby, the first shaft rotates under a restriction of the upright post to make the rotary disc and the transmitting device rotate in one direction; the second shaft and the driving gear rotate along with the rotary shaft to force the driven gear meshing with the driving gear rotating in another direction; the respective support arms displaces on the wave-shaped rail in reverse and moves up and down in the guide groove to result in the decorative article at the lower part of the respective movable rod rotates and moves up and down synchronously.

2. The elevated rotational transmission mechanism according to claim 1, wherein the transmitting device is a music bell, a stirred wheel thereof is disposed at a lateral side of the second shaft to move with respect to the second shaft, an outer surface of the stirred wheel provides a plurality of protruding granules, and a spring sheet section with a plurality of spring sheets is disposed at a lateral side of the stirred wheel may generate music sound as soon as the protruding granules interfere the spring sheets.

3. The elevated rotational transmission mechanism according to claim 1, wherein the respective elongated sleeve at the bottom thereof projects a stop ring and extends downward a threaded section to engage with a nut through the locating hole, and the stop ring is disposed in a state of striding above the locating holes.

4. The elevated rotational transmission mechanism according to claim 1, wherein the respective elongated sleeve at a top thereof fits with a limit ring to prevent the support arm from slipping away.

5. The elevated rotational transmission mechanism according to claim 1, wherein the rotary disc at the periphery thereof provides a circumferential rim or a plurality of circumferential holes to adhere or to thread-fasten to an upper cover respectively.

6. The elevated rotational transmission mechanism according to claim 1, wherein the connecting rod at a lower end part thereof passes through a fitting hole in the cylindrical head and a through hole on the driven gear to connect with the locating stem.

7. The elevated rotational transmission mechanism according to claim 1, wherein the wave-shaped rail provides a contour with a plurality of up and down arc surfaces.

8. The elevated rotational transmission mechanism according to claim 1, wherein the wave-shaped rail provides a contour with a continuous slant surface.

9. The elevated rotational transmission mechanism according to claim 1, wherein the wave-shaped rail provides a contour with a plurality of up and down straight surfaces.

10. The elevated rotational transmission mechanism according to claim 1, wherein the respective support arm at a free end thereof fits with a bearing.
